(19) United States
(12) Patent Application Publication
(10) Pub. No.: US 2016/0132791 A1
(43) Pub. Date: May 12, 2016

(54) METHODS AND SYSTEMS FOR DISTRIBUTED GRAPHICAL FLIGHT SEARCH

(71) Applicants: GraphSQL, Inc., Mountain View, CA (US); Kent State University, Kent, OH (US)

(72) Inventors: Ruoming Jin, Aurora, OH (US); Ding Chu, Fremont, CA (US)

(73) Assignees: Graph SQL, Inc.; Kent State University

(21) Appl. No.: 14/936,528

(22) Filed: Nov. 9, 2015

Related U.S. Application Data
(60) Provisional application No. 62/077,054, filed on Nov. 7, 2014.

(51) Int. Cl. G06Q 10/02; G06Q 50/14

(52) U.S. Cl. CPC G06Q 10/02; G06Q 50/14

(57) ABSTRACT

Methods and systems for real-time graphical search for airline flight itineraries that satisfy predetermined criteria (e.g., place and time) using a distributed graph processing system are disclosed. The advantages of the graphical method include: computational work is easily split across multiple processors for parallel processing; the resulting speed is appropriate for real-time personalized search; the method naturally supports multi-segment routes up to any user-specified maximum; the method easily handles constraints or freedoms on connections between flights, such as connection time or transferring to another airport in the same metropolis; and the method is efficient due to focusing only on viable flight segments.

### CROSS-REFERENCE TO RELATED APPLICATIONS

This application claims priority to U.S. Provisional Patent Application, Ser. No. 62/077,054, which was filed Nov. 7, 2014. Priority to the Provisional Application is expressly claimed, and the disclosure of the Provisional Application is hereby incorporated by reference in its entirety and for all purposes.

### FIELD

The present disclosure relates generally to graph-based relationships and more specifically, but not exclusively, to distributed computation of graph data that permits graphical flight searches.

### BACKGROUND

Conventional systems and methods enable consumers to perform searches on the Web, for example, for available airline flight itineraries from one city to another. While this technology exists, it comes at considerable computational expense. For example, one standard approach stores flight segments in relational database tables. To find a route with two segments requires a self-join of the relational database tables, which is an order of magnitude more expensive to perform (e.g., in both cost and resources) when compared to a search for nonstop flights. To consider three-segment routes requires an additional join operation, which adds another order of magnitude to the computational expense.

In order to provide a quicker response time to travel queries, a typical strategy is to pre-compute and save the solutions to common travel queries. A disadvantage of pre-searched flight itineraries is that the solution may no longer be valid: for example, seats may no longer be available on some of the flights, or the price of the itinerary may have changed.

In view of the foregoing, a need exists for systems and methods for dynamic flight route queries to overcome the aforementioned obstacles and deficiencies of conventional search systems.

### BRIEF DESCRIPTION OF THE DRAWINGS

FIG. 1 is an exemplary top-level block diagram illustrating an embodiment of a distributed graph searching system.

FIG. 2 is an exemplary diagram illustrating one embodiment of a flight table data structure maintained using the distributed graph searching system of FIG. 1.

FIG. 3 is an exemplary diagram illustrating one embodiment of a flight query data structure maintained using the distributed graph searching system of FIG. 1.

FIG. 4 is an exemplary diagram illustrating one embodiment of the flight query data structure of FIG. 3.

FIG. 5 is an exemplary flowchart illustrating one embodiment of a flight-search method using the distributed graph searching system of FIG. 1.

FIG. 6 is an exemplary diagram illustrating one embodiment of the construction of the initial query for the flight-search method of FIG. 5.

FIG. 7 is an exemplary diagram illustrating a data structure progression during a search using the flight-search method of FIG. 5.

FIG. 8 is an exemplary diagram illustrating one embodiment of a flight query data structure for bidirectional searches maintained using the flight-search method of FIG. 5.

FIG. 9 is an exemplary diagram illustrating one embodiment of a state diagram of the flight processor of FIG. 1.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

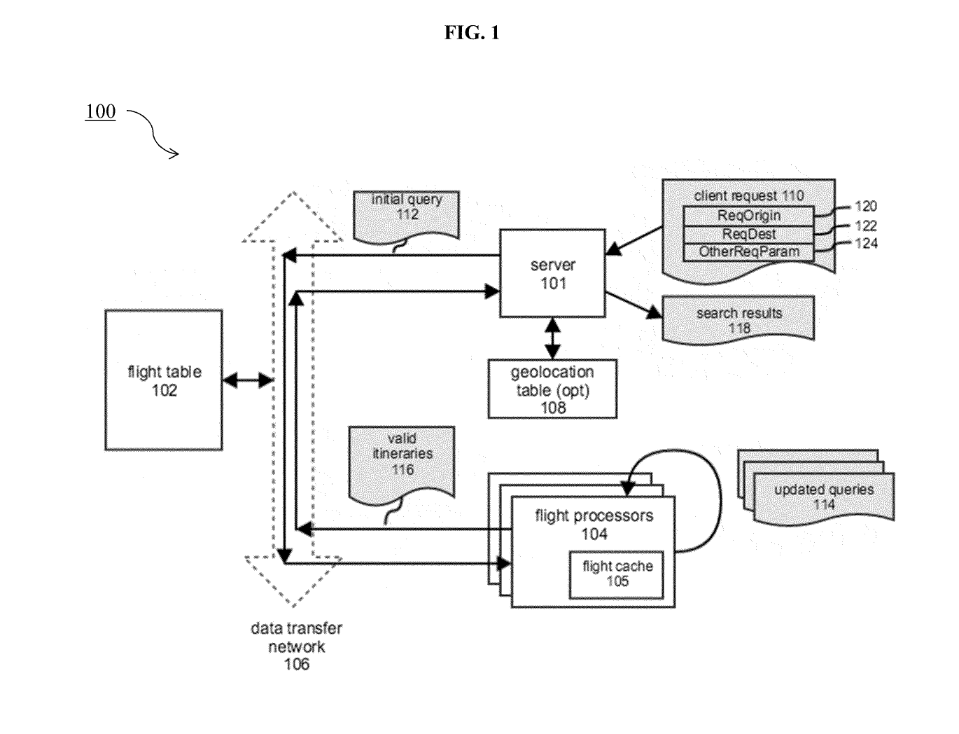

Since currently-available search systems are deficient because they require a very large number of computational steps, a system for distributed searching of graph data that provides a reduced computation cycle can prove desirable and provide a basis for a wide range of graph computation applications, such as finding a best travel itinerary for air travel. This result can be achieved, according to one embodiment disclosed herein, by a system 100 for distributed graph searching as illustrated in FIG. 1.

Referring to FIG. 1, the system 100 comprises a server 101 that manages at least one flight table 102 for storing a collection of flight segments and at least one flight processor 104. The server 101, the flight processors (FP) 104, and the flight table 102 can communicate over a data transfer network 106. Examples of the data transfer network 106 include Internet Protocol (IP) data networks, such as private networks, local area networks (LANs), and wide area networks (WANs), public networks, the Internet, and/or other packet-switched networks. In some embodiments, a geolocation table 108 records the geolocation of one or more airports.

In one embodiment, each of the FPs 104 is a programmable computational device capable of performing the basic data input, computational, and data output tasks described below. The FPs 104 can receive one or more initial queries 112 from the server 101 and one or more updated queries 114 from at least one of the FPs 104. The FPs 104 can search the flight table 102 for flights that satisfy a selected query, and can send out updated queries 114 or Valid Itineraries 116 to the other FPs 104 and/or the server 101. Each of the FPs 104 can include a flight cache 105 capable of storing a local copy of a subset of the flight segments in the flight table 102.

The FPs 104 may be implemented as hardware, software, or some combination of the two. Some embodiments of the FPs 104 include a computer, a central processing unit (CPU) chip, one or more cores of a multi-core CPU, a virtual machine, and a software object in an object-oriented language. Moreover, one or more physical or virtual devices may be combined to serve as one FP 104, and one physical computing device can support the operations of at least one FP 104.

The server 101 can be a programmable computation device equipped to accept and interpret a client request 110, to send instructions and the initial query 112 to the FPs 104, to receive the Valid Itineraries 116, and to combine the Valid Itineraries 116 into search results 118 suitable for user. In some embodiments, the client request 110 is a collection of data values that describe a desire to travel from a designated origin to a destination, along with optional constraints or preferences, such as the day of departure. In some embodiments and as shown in FIG. 1, the client request 110 includes a requested place of origin (ReqOrigin) 120, a requested destination (ReqDest) 122, and an other request parameters (OtherReqParam) 124.

Graphical Representation and Distributed Storage of Flights

A graph is an abstract data model comprising a collection of vertex points and a collection of vertex-to-vertex connections, called edges. For various applications, edges and vertices can represent any entity. For example, in the graphical method for flight search, each airport can be represented by a vertex. Each flight number is represented by a directed edge from its origin vertex to its destination vertex. A standard graph may have only one edge from an origin to a destination. Since there may be many different flights having the same origin and destination, this sort of graph is sometimes referred to as a multigraph.

Description of Data Structures

The flight table 102 and the geolocation table 108 can include expandable and revisable data structures residing on one or more electronic data storage devices. This includes, but is not limited to, persistent storage devices such as magnetic hard disks and solid state memory drives, as well as nonpersistent memory devices, such dynamic random access memory (DRAM). There can be multiple copies of the flight table 102 and the geolocation table 108, to improve efficiency or reliability.

Flight Table Format:

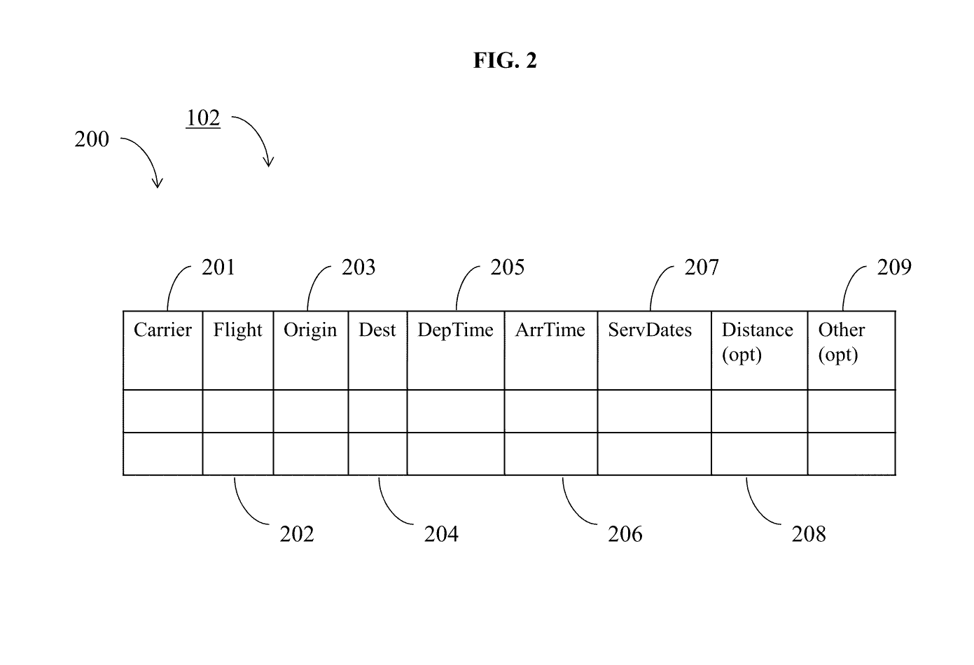

In one embodiment, the flight table 102 records all regularly scheduled flights. Conceptually, the flight table 102 is arranged in tabular format, with each row representing one flight number, and each column representing one attribute field of a flight (e.g., flight number, carrier, origin, destination, departure time, arrival time, service dates, distance, and so on). In one embodiment, the system 100 maintains airline, flight number, origin, destination, departure time, arrival time, and service dates to accurately describe a single flight. FIG. 2 illustrates one embodiment 200 of the flight table 102 that includes attribute fields of a Carrier 201, a Flight 202, an Origin 203, a Destination (Dest) 204, a Departure Time (DepTime 205), an Arrival Time (ArrTime) 206, a set of Service Dates (ServDates) 207, and two optional fields: a Distance 208 and an Other 209. Flights often cross time zones; the DepTime 205 and the ArrTime 206 can refer to the local time. In some embodiments, the Distance 208 is the great-circle distance between the Origin 203 and the Dest 204. The Other 209 field is used to describe additional information about the flight that may be relevant for the search.

Traditionally, carriers have described service dates using a start date, an end date, and code numbers 1 through 7 to indicate Monday through Sunday. For example, a flight might have a start date of Jan. 3, 2014, an end date of Apr. 15, 2014, and date codes 1, 2, 3, 4, 5, to indicate that the flight is available Monday through Friday. In one example of the ServDates 207, service dates can be represented as “01/03/2014, 04/15/2014, 12345.”

Some flights arrive on a different calendar day than the departure day. Overnight flights may arrive the next day. Flights that cross the International Date Line may arrive a day earlier or later. This additional information about arrival date can be included within the ArrTime 206 or in the Other 209 fields.

Query Format:

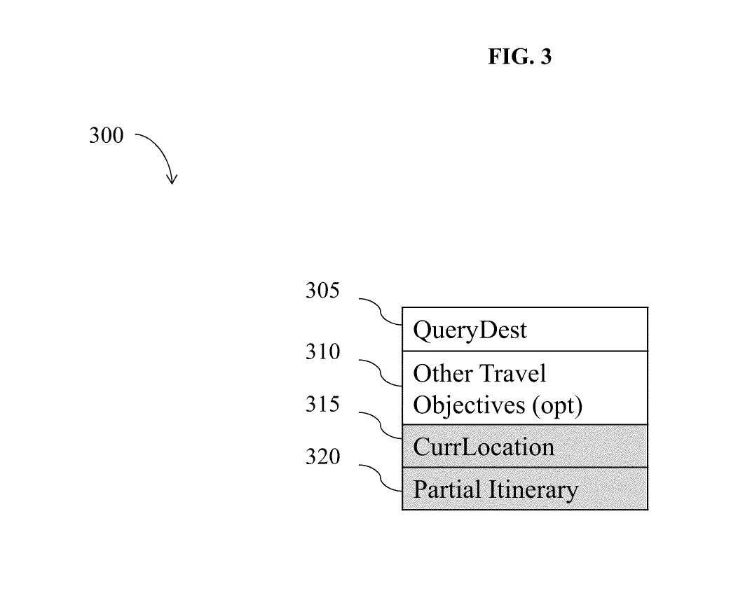

The initial query 112 and the updated queries 114 represent data records comprising a plurality of fields, which together supply the parameters for a desired air travel itinerary. Both the initial query 112 and the updated queries 114 can use the same format, but their field values may be different. FIG. 3 illustrates a high-level view of a query 300, which can include either the initial query 112 or the updated query 114, with fields for a Query Destination (QueryDest) 305, an Other Travel Objectives 310, a Current Location (CurrLocation) 315, and a Partial Itinerary 320. The server 101 uses information from the client request 110 to construct the initial query 112. The server 101 sets the QueryDest 305 and the CurrentLocation 315 of the initial query 112 to be the values of the ReqDest 122 and the ReqOrigin 120, respectively, of the client request 110. The Partial Itinerary 320 of the initial query 112 is empty. In one embodiment, itineraries are built in the forward direction, so the Partial Itinerary 320 comprises a sequence of flight segments from the ReqOrigin 120 to some intermediate airport. Accordingly, in the updated queries 114, the CurrLocation 415 is the intermediate airport at the end of the Partial Itinerary 320.

The OtherReqParam 124 of the client request 110 can include preferences for when the itinerary begins or when the itinerary ends. The server 101 can include these preferences in the Other Travel Objectives 310 of the initial query 112. The Other Travel Objectives 310 can also be used to support additional search criteria, such as specification of carriers or class of service.

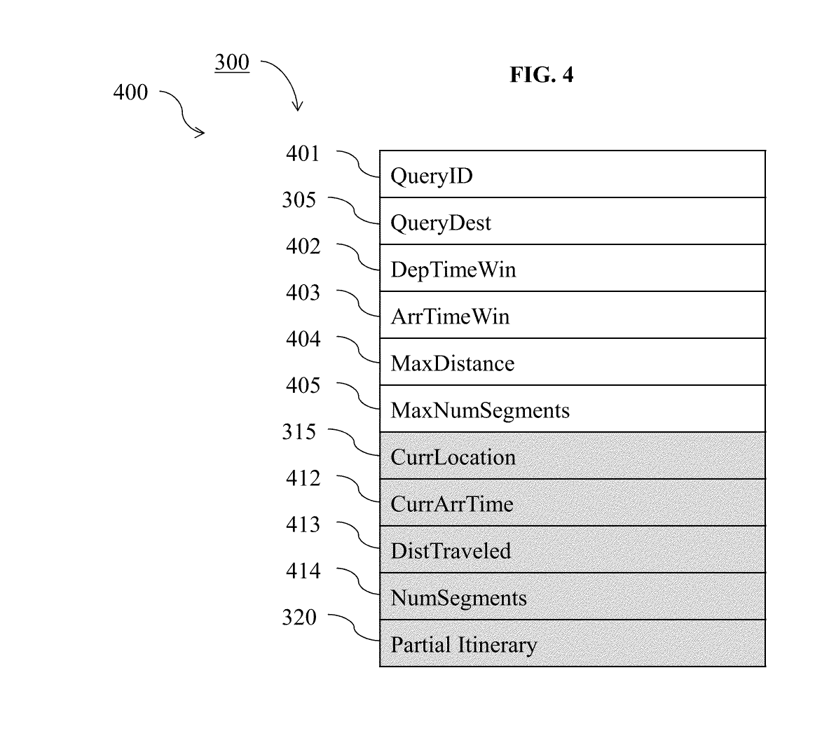

FIG. 4 shows one embodiment of a detailed view 400 of the query 300. As shown, there are six unshaded fields, describing the objectives of the initial query 112. The five shaded fields pertain to details of the Partial Itinerary 320, and their values are revised with each iterative step. While the actual arrangement of fields is not significant, the embodiment shown in FIG. 4 arranges the fields to highlight correspondences between the shaded and unshaded fields:

QueryDest 305 and CurrLocation 315 describe the two endpoints of travel.

DepTimeWin 402, ArrTimeWin 403, and CurrArrTime 412 are time factors.

MaxDistance 404 and DistTraveled 413 are distances.

MaxNumSegments 405 and NumSegments 414 are integer counts of flight segments.

The time factors (the DepTimeWin 402, the ArrTimeWin 403, and the CurrArrTime 412) and the distance factors (the MaxDistance 404 and the DistTraveled 413) can be used to aid in limiting the scope of the search and to help determine when to end the search.

Flight Search:

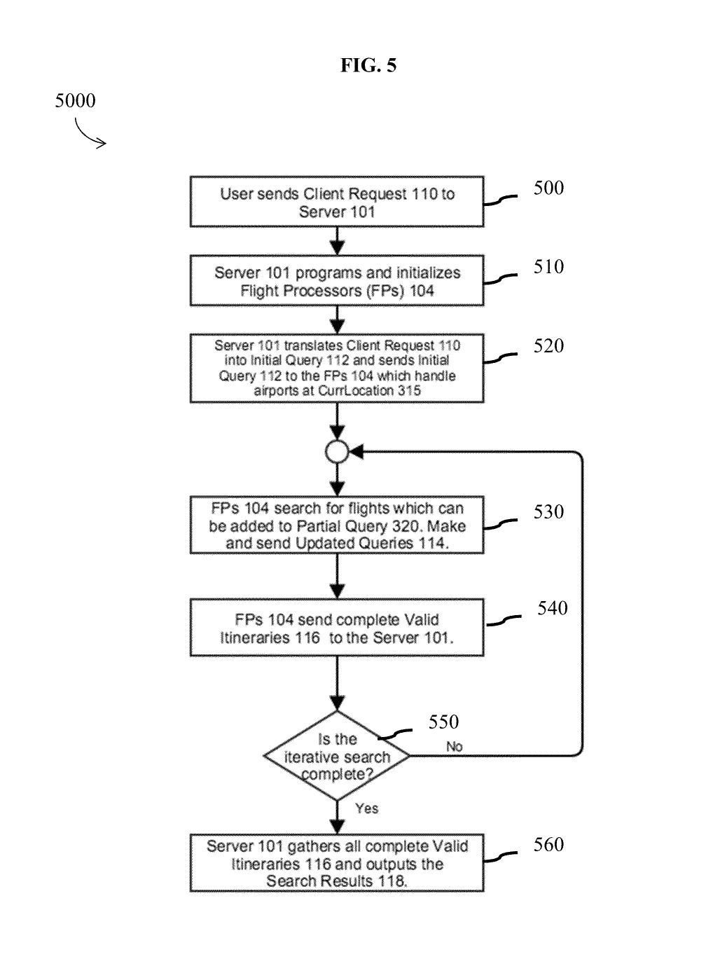

Turning to FIG. 5, one embodiment of one exemplary method 5000 for using the system 100 of FIG. 1 to search for Valid Itineraries 116 is shown.

Step 500:

The flight search method begins with Step 500, in which a user sends the client request 110 to the server 101.

Step 510:

After Step 500, the method 5000 proceeds to Step 510. The server 101 prepares and initializes the one or more FPs 104 to process the client request 110. Preparation can include setting the operating state of FPs 104 and distributing a copy of the flight table 102 among the flight caches 105. Not every client request 110 may require activity during Step 510.

Step 520:

After Step 510, the method 5000 advances to Step 520. In Step 520, the server 101 translates the client request 110 into the initial query 112, as described above, and sends it to those FPs 104 that handle the starting airport corresponding to the ReqOrigin 120. In some situations, the ReqOrigin 120 may be a plurality of airports or cities, or the ReqDest 122 may be a plurality of airports or cities. One way that the server 101 can translate a client request 110 with such plurality of locations is to decompose the client request 110 into several initial queries 112, each with only one CurrLocation 315 and one QueryDest 305. Each of these initial queries 112 is then processed (Steps 530 through 560) separately.

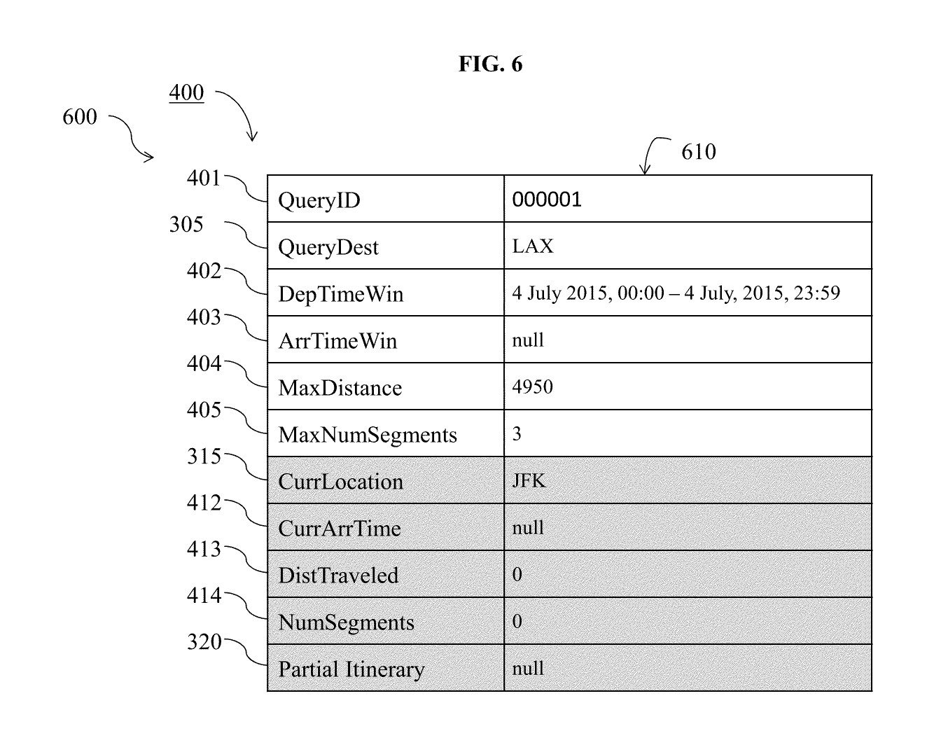

For an example of the creation of an initial query 112, suppose the client request 110 is to travel from JFK airport to LAX airport on Jul. 4, 2015. The great-circle distance from JFK to LAX is 2,475 miles. Furthermore, assume that MaxNumSegments=3 and DistanceMultiplier=2. Then the values of the initial query 112 would be as shown in FIG. 6 Since the system 100 has not yet started to select an itinerary, the DistTraveled 413 and NumSegments 414 are both 0. The initial CurrArrTime 412 is null. In some other embodiments, the CurrArrTime 412 in the initial query 112 is set to a time which the server 101 can easily recognize as impossible, such as Jan. 1, 1900. The initial Partial Itinerary 320 value should be equivalent to an empty list.

Following Step 520, the method 5000 enters an iterative loop, including a Step 530, Step 540, and Decision 550. In each round of the iterative loop, the FPs 104 search for suitable flight segments to add on to existing Partial Itineraries 320, until the latest Partial Itineraries 320 satisfy the initial query 112.

Step 530:

An Incoming Query (not shown) is the query which one of the FP 104 receives at the start of Step 530, either from the server 101 or from another FP 104. Not every FP 104 necessarily receives an Incoming Query, and some FPs 104 may receive multiple Incoming Queries. In Step 530, each FP 104 that receives an Incoming Query searches for flights that meet the criteria in the Incoming Query. The FP 104 searches either the flight table 102 or its flight cache 105. In some embodiments, any flight which satisfies the DepTimeWin 402 requirement and which would not cause the new Partial Itinerary 320 to exceed the MaxDistance 404 condition is considered a valid next flight. The FP 104 uses each valid next flight to construct an updated query 114. The FP 104 concludes Step 530 by sending its updated queries 114 to the other FPs 104.

One example method for Step 530 for one instance of the FP 104 is shown below, in which variable Q is the Incoming Query that FP 104 receives, R is an updated query 114 sent out by FP 104, and UpdatedQueryList is a collection of zero or more updated queries 114. The variable FlightCache is the flight cache 105 of the FP 104, containing the local copy of selected flight segments from flight table 102.

Given Incoming Query Q:

```
  Clear the UpdatedQueryList
  For each flight F in FlightCache:
```

| | |
|---|---|
| if( | F.DepTime is within Q.DepTimeWin |

| | |
|---|---|
| and | F.Distance < (Q.MaxDistance − Q.DistTraveled)) |

R := CreateNewQuery(Q, F)
Add R to UpdatedQueryList

Return UpdatedQueryList

The function CreateNewQuery creates a new query R with the following attributes:

R.CurrLocation := F.Destination
R.CurrArrTime := F.CurrArrTime
R.DistanceTraveled := Q.DistanceTraveled + F.distance
R.NumSegments := Q.NumSegments + 1

The updated query R also requires a value for DepTimeWin 402. As a reminder, the DepTimeWin 402 of updated query R is the requested range of departure times for the next flight after flight F in the flight itinerary. The DepTimeWin 402 has two parts, a start time and an end time. The start time is the earliest reasonable time that the traveler can board another flight after the arrival of flight F. This relation can be expressed as R.DepTimeWin.start=F.ArrTime+ConnectionTime.

ConnectionTime should be large enough for several possible activities and delays. ConnectionTime includes time for the passenger to disembark from one plane, find out where is the next gate, and walk to the next gate. In large airports, these activities may take on the order of thirty minutes. A reasonable value for ConnectionTime also takes into account late arrival of the incoming flight, whether passengers must pass through a security check, whether passengers must pass through immigration and customs, and whether passengers must claim checked baggage and re-check their bags.

Each FP 104 has one value or a selection of values to choose from for ConnectionTime. In some embodiments, the FP 104 chooses from different fixed values for each airport. In some embodiments, the FP 104 chooses a value based on the time of day that flight F arrives. In some embodiments, the FP 104 chooses different values for domestic vs. international connections. In some embodiments, the OtherReqParam 124 includes a range (minimum and maximum) of acceptable ConnectionTime values.

Each FP 104 is assigned a fixed set of airports and can easily and conveniently store the ConnectionTimes associated with those airports.

The end time of DepTimeWin 402 requires some additional considerations. Suppose the initial query 112 specified a departure any time on a given day, so the width of DepTimeWin 402 of the initial query 112 is twenty-four hours. However, most travelers do not want to wait twenty-four hours for connections, regardless of their flexibility for initial departure time. On the other hand, suppose another initial query 112 has a DepTimeWin 402 of only two hours. While there may be initial departing flights within a two-hour window, there may not be any connecting flights within a similarly small time window.

Accordingly, a method for choosing the end of DepTimeWin 402 for an updated query 114 is to target a reasonable time window for connecting flights. For example, R.DepTimeWin.end=R.DepTimeWin.start+ConnectionTimeWidth, where ConnectionTimeWidth has a value such as four hours or six hours.

In some situations, especially for international routes or routes through less-popular cities, there may be no flights within the given time window. An alternative method, which focuses on finding the best available connections, can be used.

For example, rather than using a fixed ConnectionTimeWidth value, another method is to search for the connecting flights with the shortest connection times, which satisfy the minimum ConnectionTime constraint. In one embodiment, the FPs 104 look for a set number of connecting flights. Such an embodiment would benefit if flights are pre-sorted in order of departure time. For example, the FPs 104 can be programmed to find the five earliest flights departing ATL for each possible destination city. If the incoming flight arrived at 1:00 pm and the minimum connection time parameter is set to thirty minutes, that the earliest possible flights would depart ATL at 1:30 pm. If the flight list is pre-sorted, the FP 104 can quickly look up the first flight no sooner than 1:30 pm and also read the next four flights.

Step 540:

During Step 530, when the FP 104 is searching its flight cache 105 (or the flight table 102) for flights that satisfy the Incoming Query, if the FP 104 finds a valid next flight that arrives at the QueryDest 305, and which satisfies the other requirements of the Incoming Query, then the FP 104 has identified the components of the Valid Itinerary 116. The step 540 includes the construction and transmission of Valid Itineraries 116 to the server 101. The step 540 may either take place after, or concurrently with, Step 530. To make the complete Valid Itinerary 116, the FP 104 appends the valid next flight to the Partial Itinerary 320 in the Incoming Query. The FP 104 does not need to create an updated query 114 for this flight. For example, if the FP 104 which handles flights departing from Florence (FCO) is processing an Incoming Query which requests an itinerary to Pisa (PSA), then nonstop flight segments from FCO to PSA potentially satisfy the query. The FP 104 for FCO does not need to send an updated query 114 to the FP 104 that handles PSA. Instead, the FP 104 for FCO assembles the complete itinerary information as the Valid Itinerary 116 and sends the Valid Itinerary 116 to the server 101.

Decision 550:

After completing Step 530 and Step 540 for the current iteration, the FPs 104 and server 101 perform Decision 550 to choose whether to perform another iteration or to stop iterations and to continue instead to Step 560. The common conditions for terminating iterations are that the iteration count (which is equal to the NumSegments 414) has reached or exceeded MaxNumSegments 405, or that DistTraveled 413 has reached or exceeded MaxDistance 404, or that the FPs 104 have found a sufficient number of Valid Itineraries 116. In some embodiments, each FP 104 decides independently whether to continue an iteration, and the server 101 monitors the FPs 104 to see whether any of them are still executing an iteration. When none of the FPs 104 are iterating, then the server 101 continues on to Step 560.

For example, if MaxNumSegments=3, then the FP 104 does not return to Step 530 after the third iteration. In some cases, the source of the MaxNumSegments 405 limit is a user request (via OtherReqParam 124); it other cases the server 101 has a fixed limit that the server 101 inserts into the initial query 112.

The MaxDistance 404 is used to filter out travel itineraries that are too long. In some embodiments, the value of MaxDistance 404 is equal to the minimum (great-circle) distance from ReqOrigin 120 to ReqDest 122 times a numeric parameter DistanceMultiplier (not shown). The DistanceMultiplier may be specified by the user (via OtherReqParam 124) or may be fixed by the server 101. For example, if the minimum distance is one thousand miles and the DistanceMultiplier is two, then the MaxDistance 404 is two-thousand miles.

The great-circle minimum distance between two locations on the globe can be mathematically computed based on the geographic locations of the two cities, regardless of whether any nonstop service between the two cities actually exists. In an embodiment that is using the MaxDistance 404 and DistanceMultiplier option, the server 101 needs to know the great-circle minimum distance when the server 101 is constructing the initial query 112. As previously discussed, the system 100 includes the geolocation table 108 that stores the latitude and longitude or equivalent information for each airport. Given the geolocation of the ReqOrigin 120 and the ReqDest 122, the server 101 can apply a standard formula to compute the ideal air travel distance between the two points.

In some embodiments, each of the FP 104 sends the Valid Itineraries 116 to the server 101 as soon as the FP 104 has found the final flight segment that completes the initial query 112. When the server 101 has received a predetermined number of the Valid Itineraries 116, the server 101 sends instructions to the FPs 104 to terminate their searches.

Step 560: Gather and Present Results to User

In the final step of the flight search method 5000, the server 101 gathers all the Valid Itineraries 116 together and presents them in user-friendly format as the search results 118. Step 560 can include expanding the abbreviations and codes used in the flight table 102 and the Valid Itineraries 116 into more human-friendly language and sorting the results by some criteria such earliest departures first or shortest overall travel time first.

With reference again the Iterative Search (Step 530), an example is provided. Suppose a traveler wishes to fly from St. Louis, Mo. (STL) to Pisa, Italy (PSA). Neither city is a major international hub, so the itinerary will likely require multiple segments. One possible route is STL→ATL (Atlanta)→FCO (Florence, Italy)→PSA.

In one embodiment, the flight search method 5000 employs three iterations to construct this itinerary. In the first iteration, the FPs 104 consider flights departing from STL and determine that a flight to ATL satisfies the Incoming Query. A flight from STL to ATL constitutes a Partial Itinerary 320. In the second iteration, the FPs 104 consider flights departing from ATL and determine that a flight to FCO satisfies the Incoming Query. An FTP 104 appends this flight segment to construct a longer Partial Itinerary 320: {STL→ATL, ATL→FCO}. In the third iteration, the FPs 104 consider flights departing from FCO and determine that a flight to PSA satisfies the Incoming Query. An FP 104 appends this segment to construct a longer Partial Itinerary 320: {STL→ATL, ATL→FCO, FCO→PSA}. Since PSA is the desired destination, this is a Valid Itinerary 116, which the FP 104 sends to the server 101 in Step 540. In this example, each iteration can consider other destinations, as well as different flights to and from ATL and FCO, so multiple itineraries are likely to be discovered.

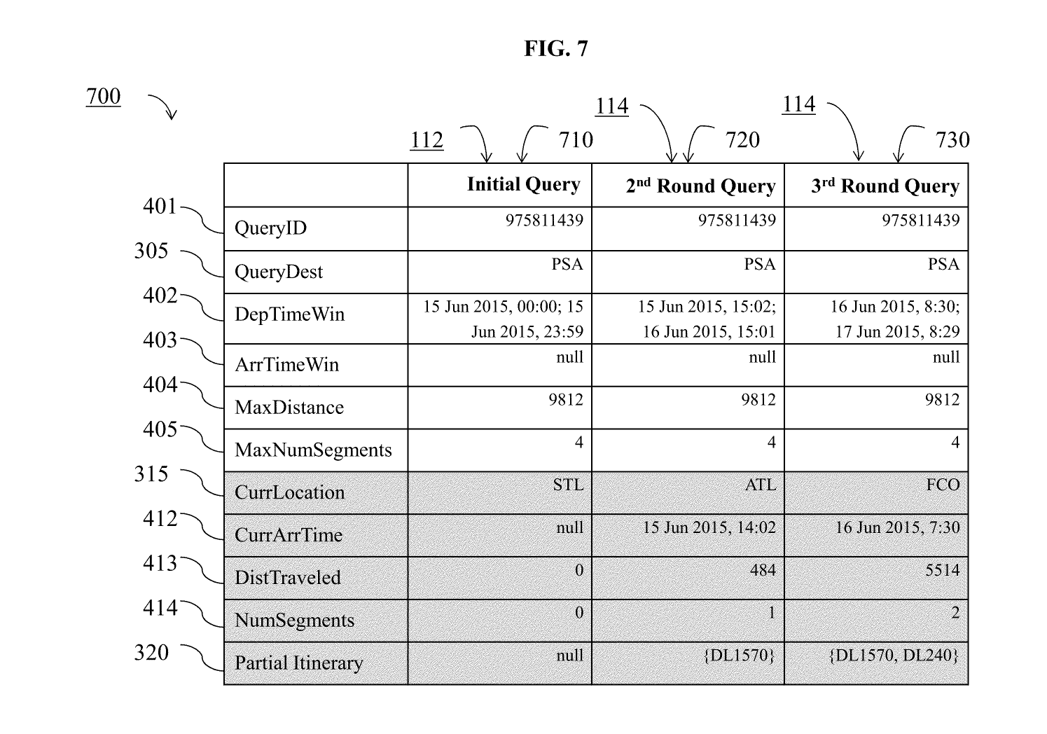

With reference to FIG. 7, a specific example 700 can illustrate the progression of queries, the Partial Itineraries 320, and searches of the Step 530 toward a Valid Itinerary 116. Suppose a traveler wishes to travel from St. Louis (STL) to Pisa, Italy (PSA) on Jun. 15, 2015. The traveler is willing to depart at anytime during that day and does not specify an arrival time.

The corresponding initial query 112 is shown in the second column (initial query 710) of the table in FIG. 7. During the first iteration of Step 230, one of the FPs 104 notes one of the many flights that depart STL on June 15 is DL1570, arriving in ATL at 2:02 PM (local time) in the afternoon after traveling 484 miles. The FP 104 in the first round creates the updated query 114 that becomes the second round query 720. The FP 104 that discovered flight DL1570 in the first round revises the DepTimeWin 402 in second round query 720 to start after the arrival time of the incoming flight DL1570. The other unshaded rows (top six rows after the header) of the second round query 720 are the same as in the initial query 710, because the overall objectives of the search are the same. All of the shaded (bottom five) rows have been updated to include the effect of the flight DL1570. The second round query 720 shown in FIG. 7 is specific to the flight DL1570; however, there can be many different updated queries 114 in the second round, one for each result from the initial query 710.

In the second round, another FP 104 discovers flight DL240, from ATL to FCO. Flight DL240 departs ATL at 3:57 pm, satisfying the DepTimeWin 402 of the second round updated query 720, and arrives in Florence, Italy at 7:30 am on June 16, traveling 5,030 miles.

The FP 104 that identified flight DL240 in the second round creates the updated query 114 that becomes a third round query 730 shown in FIG. 7. Flight DL240 is appended to the Partial Itinerary 320 of second round query 720 to form the Partial Itinerary 320 of the third round query 730, now consisting of the flight sequence {DL1570→DL240}. The DepTimeWin 402 has again been shifted to start after the arrival of the last flight in the Partial Itinerary 320. DistTraveled 413 in third round query 730 is the sum of the Distance 208 of DL240 plus the DistTraveled 413 in the previous query. The NumSegments 414 is incremented again.

Other embodiments could use different data fields in the queries. For example, price information and fare rule information is relevant for many users. The data structures of flight table 102 and the query 300 could be modified to include this information. The flight search method 5000 could be modified to take price preferences and fare rules into consideration. The basic idea is that of performing segment-by-segment search on a graph structure.

Reverse Direction Search:

In some embodiments, the system 100 and flight search method 5000 can construct itineraries in the reverse direction. The CurrLocation 315 of initial query 112 is set to be the ReqDest 122, not the ReqOrigin 120, and each iteration considers flights that arrive at the CurrLocation 315. For example, for the initial query 112 requesting itineraries from St. Louis (STL) to Pisa (PSA), the CurrLocation 315 is PSA. In the first iteration, the FPs 104 identify flights that arrive at PSA. While the majority of examples in this disclosure are for forward searches, this disclosure encompasses the construction of itineraries in the reverse direction as well.

In some embodiments, a reverse search can introduce additional considerations. For example, the initial query 112 in some searches specifies the date and preferred time window of departure, but not the date of arrival. The user may be willing to accept flight itineraries that arrive on a different date than the departure date. Moreover, if the itinerary crosses several time zones, it may be essential that the arrival date be different than the departure date. In some embodiments, when the system engages in a reverse direction search, the server 101 computes the ArrTimeWin 403 (the starting point for a reverse search) by taking the DepTimeWin 402, adding to it an estimated range of time durations for the complete itinerary, and making offsets for time zone changes. As a result, the arrival date may be a different day than the departure date. In some embodiments and in some instances of client request 110, the ArrTimeWin 403 may span more than one day, even if the DepTimeWin 402 spanned only one day. Note that when the user specifies an arrival time window but not a departure time window, a reverse direction search may be the preferred method.

Bidirectional Search:

In another embodiment of the system 100 and flight search method 5000, the server 101 issues simultaneously the initial queries 112 for both forward searches and reverse searches. To use the same example for STL→PSA travel, one initial query 112 specifies a forward search from STL to PSA. The other initial query 112 specifies a reverse search, beginning at the destination of PSA and working backwards towards STL. A complete Valid Itinerary 116 is achieved when a forward-going Partial Itinerary 320 reaches the same location as a backward-going Partial Itinerary 320, with acceptable timing between the connecting flights.

A bidirectional search is advantageous over either a forward search or a reverse search alone due to a reduced number of graph edges to consider. For example, consider a forward search in which each airport has an average of one hundred outbound flights. Of those one hundred, twenty percent satisfy the constraints of the query. This means that for each Incoming Query in the current iteration, there will be one hundred×twenty percent=twenty updated queries 114 in the next iteration. In a unidirectional search, the flight search method 5000 takes two iterations to make a two-segment itinerary, with twenty×twenty=four hundred updated queries 114. Conversely, a bidirectional search needs a single iteration to make a two-segment itinerary, with an average of twenty+twenty=forty updated queries 114.

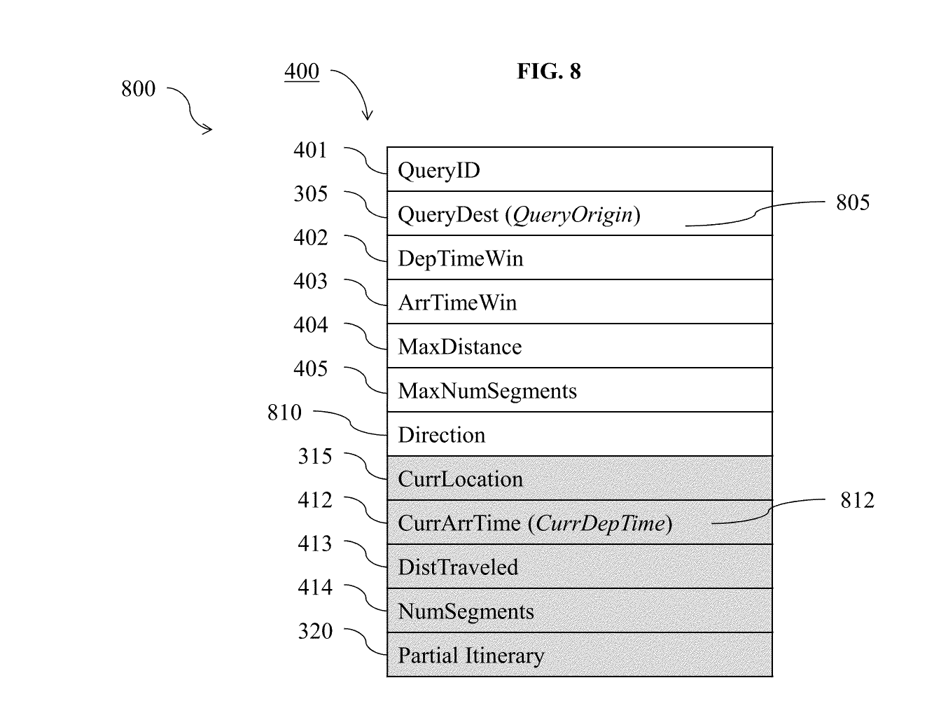

FIG. 8 shows a possible query format 800 for a bidirectional search. Compared to the query format in FIG. 4, there is one additional field, the Direction 810. If the value of Direction 810 is “Forward,” then the FPs 104 interpret the other fields as described previously for a forward search. If the value of Direction 810 is “Reverse,” then some of the data fields are interpreted differently. In the reverse case, the following data field names are more apt.

(QueryOrigin) 805 is a renaming of QueryDest 305, indicating where the traveler ultimately wishes to start, instead of end, the journey.

(CurrDepTime) 812 is a renaming of CurrArrTime 412, indicating the departure time of the earliest flight, instead of the arrival time of the last flight, in the Partial Itinerary 420.

Assignment of Flights to FPs 104:

In some embodiments, the entire flight table 102 is partitioned among a set of FPs 104, with each FP 104 copying its assigned portion of the flight table 102 into its flight cache 105. In this way, each FP 104 has fast and direct access to a set of flights, with no need to access the more distant and slower flight table 102 nor to burden the data transfer network 106 with unnecessary traffic. This copying of the flight table 102 can occur just once each time that the flight table 102 is created or updated; the partitioning and distribution does not need to be repeated for each client request 110. However, the flight table 102 may repeat the partitioning and distribution if the server 101 desires a different partitioning than the one currently in place.

Since the Incoming Queries direct the FPs 104 to search for flights based on the CurrLocation 315, flights are grouped by airport. A forward search begins by considering all the flights departing from a particular airport. To minimize the number of FPs 104 actively engaged in Step 530 and the number of updated queries 114 which the FPs 104 generate, a preferred embodiment assigns to each FP 104 flights from only one or a small number of departure airports. A reverse search, in contrast, is interested in flights which all arrive at the same airport. This requires a different group of flights. To perform bidirectional search, one embodiment of the system 100 stores two copies of the flight table 102 among the FPs 104. One copy has flights grouped by departure city for forward search, and the other is grouped by arrival city for reverse search. Furthermore, the flight cache 105 is split into two halves, one for storing flights sorted by departure location, the other for storing flights sorted by arrival location.

In some embodiments, each FP 104 handles flights from only one airport. However, some airports are much more busy than others. To help to balance the workload across the physical system, another embodiment combines the flights from several low-traffic airports into one physical FP 104. On the other hand, the numerous flights from busy hub airports, such as ORD, ATL, LHR, and PEK, are distributed across several FPs 104 so that the FPs 104 can work in parallel and reduce throughput time.

FP States:

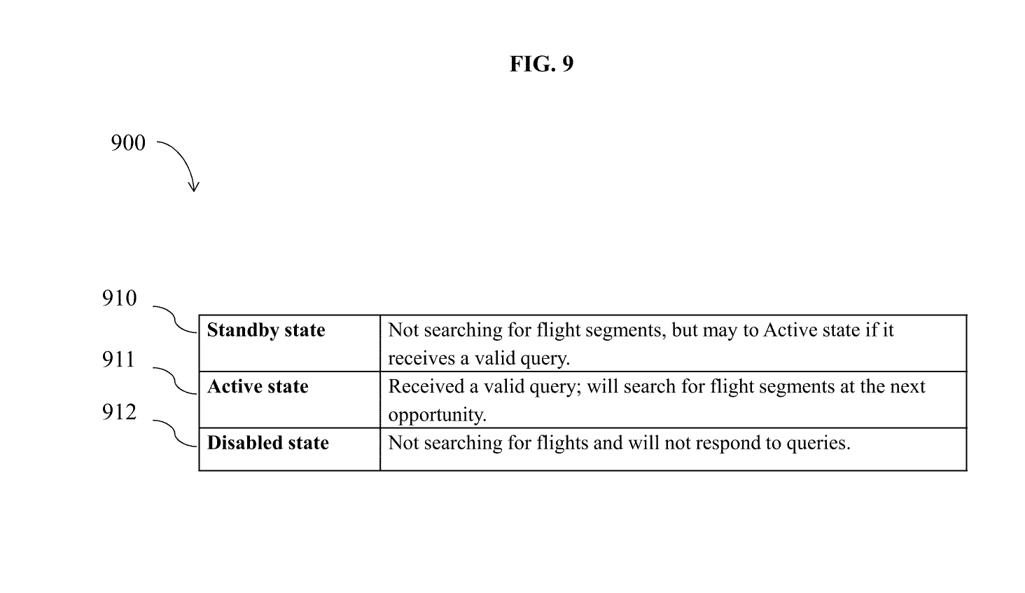

In some basic embodiments, FPs 104 respond whenever they receive a request. In some other embodiments, it is useful to regulate the responses of FPs by introducing additional states. FIG. 9 lists some possible states. The default state is the Standby state 910: the FP 104 is not searching but it will transition to the Active state 911 if the FP 104 receives a valid Incoming Query. An FP 104 in the Active state 901 is searching for flight segments to add to a Partial Itinerary 320 of an Incoming Query. In some embodiments, initial queries 112 and updated queries 114 are broadcast to all FPs 104. In order for an Incoming Query to be valid for a particular FP 104, the CurrLocation 315 of the Incoming Query must match one of the airports handled by the FP 104.

If the server 101 wishes to exclude some FPs 104 from consideration, the server 101 can initialize those FPs 104 (say, in Step 510) to the Disabled state 902. A FP 104 in the Disabled state 902 is not searching and will not respond to any Incoming Queries. The Disabled state 902 has many potential uses. Disabled state 902 can be used to exclude certain airports, such as those outside the United States. If flights are partitioned according to class of service (e.g., economy, business, or first), the server 101 can use the Disabled state 902 to exclude classes of service. The server 101 can also use the Disabled state 902 to prevent the system 100 and flight search method 5000 from accidentally creating itineraries which contain an extraneous loop. For example, in some embodiments, an FP 104 places itself in the Disabled state 902 after completing one iteration in the Active state 901. This prevents the FP 104 from being used a second time in the same itinerary, which would be an indication of a loop.

Three FP States

Standby 900 Not searching for flight segments, but may become Active if it receives a valid query.

Active 901 Received a valid query; will search for flight segments at the next opportunity.

Disabled 902 Not searching for flights and will not respond to queries.

Additional Advantages Offered by Graph-Based Flight Search

Metropolitan Inter-Airport Connections:

One challenge in flight search is dealing with the special case when a metropolitan area has more than one airport, and a reasonable itinerary exists which involves the traveler using non-air transportation to get from one airport to another. For example, the New York area has three major airports: John F. Kennedy (JFK), LaGuardia (LGA), and Newark (EWR). One possible itinerary from STL to PSA would be {STL→LGA, JFK→FCO, FCO→PSA}. The passenger needs to take ground transportation to get from LGA to JFK. Though this adds some inconvenience and added costs, those disadvantages might be outweighed by lower overall costs and better overall scheduling.

The system 100 can easily handle such inter-airport connections, by treating the ground connection as a special type of flight. In some embodiments, a connection from LGA to JFK can be entered into the flight cache 105 of the FPs 104 handling departures from LGA with these special attributes:

Carrier 201 = ground
Origin 203 = LGA
Dest 204 = JFK
DepTime 205 = any
ArrTime 206 = DepTime + duration of ground connection

Steered Search

While many itineraries are theoretically possible, customers generally do not want itineraries with long segments that travel in a direction very different from the overall direction of travel from ReqOrigin 122 to ReqDest 124. Therefore, the system 100 and flight search method 5000 can reduce the search efforts and produce more desirable results by filtering out flights that are strongly on the wrong direction.

In some embodiments, the directionality of flights is used to filter out poor choices. To support this option, the initial query 112 contains fields for Direction 810 and MaxDistance 404. In the prior discussion about reverse and bidirectional search, Direction 810 had only two values, “Forward” and “Reverse”. In a steered search, Direction 810 indicates a radial direction, such as a compass direction or a standard 360° angle. Each flight in the flight table 102 also records the Direction 810 of its flight. Each FP 104 is programmed to eliminate from consideration long flights that travel in a direction very different from the Direction 810 of the initial query 112.

For example, suppose an initial query 112 requests to travel three thousand miles at 80° East. The FPs 104 might be programmed to accept segments in any direction, as long as the segment's Distance 208 is less than twenty five percent of the overall great-circle minimum distance of three thousand miles. Further, the FPs 104 might be programmed to only consider long flights if the flight's direction is within 90° of the Direction 810 of the initial query 112. In this case, that would be generally eastern, veering as far northward as 10° NW or as far southward as 10° SE. Different formulas are possible, such as ones that apply a continuous scale: the longer the flight, the closer the segment direction must be to the Direction 810 of the initial query 112.

In some other embodiments, the locations of airports are used to filter out poor itineraries. In some embodiments, the system examines the latitude and longitude of the ReqOrigin 122 and ReqDest 124. If the map of the world were flattened, as in a Mercator projection, then these two points define opposite corners of a rectangle. In a strictly steered itinerary, the FPs 104 could require all intermediate airports for connecting flights to be located within this bounding box. In another embodiment, the FPs 104 expand the bounding box by some proportional or set amount, to allow for short connecting flights that do not offer the shortest route but are preferable due to some other factor such as price or schedule.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives.

What is claimed is:

1. A computer-implemented method for distributed search of a graph having one or more edges, each of the one or more edges connecting a source vertex and an endpoint vertex, the method comprising:
receiving a client request including a request origin and a request destination;
translating the received client request into one or more initial queries, at least one of the initial queries including the request origin and at least one of the initial queries including the request destination;
distributing the one or more initial queries to one or more flight processors, each of the flight processors assigned to handle the source vertex corresponding to the request origin of the one or more initial queries;
searching, via the one or more flight processors, for the one or more edges to be added to a partial itinerary, wherein a selected edge is added to the partial itinerary where the endpoint vertex of the selected edge corresponds to the request destination of the initial queries; and
appending the one or more edges of the partial itinerary to form a valid itinerary.

2. The computer-implemented method of claim 1, wherein said searching includes looking up in a flight table for the one or more edges, the flight table maintaining one or more edges of the graph, each edge corresponding to an airline flight.

3. The computer-implemented method of claim 2, wherein the flight table further maintains at least one of a carrier, a flight, an origin, a destination, a departure time, an arrival time, a set of service dates, and a distance for each edge of the graph.

4. The computer-implemented method of claim 3, wherein the one or more initial queries includes at least one of a query identification, a query destination, a departure time window, an arrival time window, a maximum distance, a maximum number of segments, a current location, a current arrival time, a distance traveled, and a number of segments, and
wherein the partial itinerary is represented by the current location, the current arrival time, the distance traveled, and the number of segments.

5. The computer-implemented method of claim 4, wherein said searching further includes updating the partial itinerary for each search of each of the initial queries.

6. The computer-implemented method of claim 1, wherein at least one of the source vertices and the endpoint vertices represent at least one of an airport, a travel origin, and a travel destination.

7. The computer-implemented method of claim 1, wherein said searching includes an iterative search for the selected edge.

8. A computer-implemented method for distributed search of a graph having one or more edges, each of the one or more edges connecting a source vertex and an endpoint vertex, the method comprising:
receiving a client request including a request origin and a request destination;
translating the received client request into one or more initial queries, at least one of the initial queries including the request origin and at least one of the initial queries including the request destination;
distributing the one or more initial queries to one or more flight processors, each of the flight processors assigned to handle the endpoint vertex corresponding to the request destination of the one or more initial queries;
searching, via the one or more flight processors, for the one or more edges to be added to a partial itinerary, wherein a selected edge is added to the partial itinerary where the source vertex of the selected edge corresponds to the request origin of the initial queries; and
prepending the one or more edges of the partial itinerary to form a valid itinerary.

9. The computer-implemented method of claim 8, wherein said searching includes looking up in a flight table for the one or more edges, the flight table maintaining one or more edges of the graph, each edge corresponding to an airline flight.

10. The computer-implemented method of claim 9, wherein the flight table further maintains at least one of a carrier, a flight, an origin, a destination, a departure time, an arrival time, a set of service dates, and a distance for each edge of the graph.

11. The computer-implemented method of claim 10, wherein the one or more initial queries includes at least one of a query identification, a query destination, a departure time window, an arrival time window, a maximum distance, a maximum number of segments, a current location, a current arrival time, a distance traveled, and a number of segments, and
wherein the partial itinerary is represented by the current location, the current arrival time, the distance traveled, and the number of segments.

12. The computer-implemented method of claim 11, wherein said searching further includes updating the partial itinerary for each search of each of the initial queries.

13. The computer-implemented method of claim 9, wherein at least one of the source vertices and the endpoint vertices represent at least one of an airport, a travel origin, and a travel destination.

14. The computer-implemented method of claim 8, wherein said searching includes an iterative search for the selected edge.

15. A system for distributed search of a graph having one or more edges, each of the one or more edges connecting a source vertex and an endpoint vertex, the system comprising:
a server for receiving a client request including a request origin and a request destination and translating the received client request into at least two or more initial queries, at least one of the initial queries including the request origin and at least one of the initial queries including the request destination;
a flight table for maintaining the graph, wherein each edge of the graph corresponds to an airline flight; and
one or more flight processors for receiving the one or more initial queries from said server, at least one of the flight processors assigned to handle the source vertex corresponding to the request origin of the one or more initial queries, at least one of the flight processors assigned to handle the endpoint vertex corresponding to the request destination of the one or more initial queries, and searching for the one or more edges to be added to a partial itinerary, wherein a selected edge is added to the partial itinerary where at least one of the endpoint vertex of the selected edge corresponds to the request destination of the initial queries and the source vertex of the selected edge corresponds to the request origin of the initial queries,
wherein said one or more flight processors further joins the one or more edges of the partial itinerary to form a valid itinerary.

16. The system of claim 15, at least one of said one or more flight processors further includes a flight cache for maintaining a local copy of a subset of the graph maintained in said flight table.

17. The system of claim 15, wherein the flight table further maintains at least one of a carrier, a flight, an origin, a destination, a departure time, an arrival time, a set of service dates, and a distance for each edge of the graph.

18. The system of claim 17, wherein the one or more initial queries includes at least one of a query identification, a query destination, a departure time window, an arrival time window, a maximum distance, a maximum number of segments, a current location, a current arrival time, a distance traveled, and a number of segments, and
wherein the partial itinerary is represented by the current location, the current arrival time, the distance traveled, and the number of segments.

19. The system of claim 15, wherein said one or more flight processors further updates the partial itinerary for each search of each of the initial queries.

20. The system of claim 15, wherein at least one of the source vertices and the endpoint vertices represent at least one of an airport, a travel origin, and a travel destination.
